(19) United States
(12) Patent Application Publication
(10) Pub. No.: US 2023/0331139 A1
(43) Pub. Date: Oct. 19, 2023

(54) SYSTEMS AND METHODS FOR ACTUATED DETENTS ON AN INTERIOR SURFACE OF A VEHICLE

(71) Applicant: Toyota Research Institute, Inc., Los Altos, CA (US)

(72) Inventors: Hiroshi Yasuda, San Francisco, CA (US); Manuel Ludwig Kuehner, Mountain View, CA (US); Jaime S. Camhi, Los Gatos, CA (US)

(73) Assignees: Toyota Research Institute, Inc., Los Altos, CA (US); Toyota Jidosha Kabushiki Kaisha, Toyota-shi (JP)

(21) Appl. No.: 17/721,461

(22) Filed: Apr. 15, 2022

(51) Int. Cl. B60P 7/08; B60R 5/04

(52) U.S. Cl. CPC B60P 7/0892; B60R 5/04

(57) ABSTRACT

Systems, methods, and other embodiments described herein relate to securing an object on a surface of a vehicle. In one embodiment, a method includes identifying a subset of detents in a plurality of detents disposed within a vehicle surface of a vehicle based upon sensor data generated by internal sensors of the vehicle, wherein the sensor data is indicative of dimensions of an object located on the vehicle surface. The method further includes transmiting a signal to an actuator of the vehicle, wherein the signal causes the actuator to extend the subset of detents from a non-extended position to an extended position, and wherein the subset of detents conforms to the dimensions of the object when the subset of detents is in the extended position.

### TECHNICAL FIELD

The subject matter described herein relates, in general, to securing an object on an interior surface of a vehicle, and, more particularly, to utilizing actuated detents to secure the object.

### BACKGROUND

As a vehicle navigates about an environment, positions of objects (e.g., cargo) placed on an interior surface of the vehicle (e.g., a floor) may shift due to acceleration/deceleration of the vehicle and/or due to uneven road surfaces (e.g., potholes) traversed by the vehicle. This is undesirable, as the cargo within the vehicle may be at risk for damage when positions of the cargo change suddenly. For instance, if the vehicle brakes suddenly, cargo within the vehicle may fall over, collide with a cabin door of the vehicle, etc. Furthermore, noise may be produced when positions of the cargo shift, which may annoy occupants of the vehicle. Some conventional vehicles may be equipped with cargo nets and/or straps that may be utilized to secure cargo. However, cargo nets and/or straps may be aesthetically unappealing to occupants of the vehicle. Additionally, cargo nets and/or straps take up valuable cabin space within the vehicle, even when there is no cargo to secure within the vehicle. Moreover, cargo nets and/or straps require a person to physically place the cargo nets and/or straps over/around cargo in order to secure the cargo. Furthermore, cargo nets and/or straps may not be adaptable to cargo of varying dimensions and hence may be unable to secure such cargo.

### SUMMARY

Example systems and methods relating to securing an object located on an interior surface of the vehicle is disclosed herein. According to embodiments, the system comprises a plurality of detents that are disposed within a vehicle surface on an interior of the vehicle. The system also comprises an actuator that is configured to apply uniform pressure to the plurality of detents in an upwards direction. When an object is located on the vehicle surface, a first subset of detents in the plurality of detents extends from a non-extended position to an extended position, where the subset of detents conforms to dimensions of the object. A second subset of the plurality of detents is located directly beneath the object and does not extend from the non-extended position due to a weight of the object. Thus, the system secures the object on the vehicle surface. According to embodiments, a computing system identifies a subset of detents in a plurality of detents disposed within the vehicle surface based upon sensor data generated by internal sensors of the vehicle, where the sensor data is indicative of dimensions of an object located on the vehicle surface. The computing system transmits a signal to an actuator of the vehicle, where the signal causes the actuator to extend the subset of detents from a non-extended position to an extended position. The subset of detents conforms to the dimensions of the object when the subset of detents is in the extended position. A second subset of detents in the plurality of detents is located directly beneath the object. The actuator does not extend the second subset of detents from the non-extended position to the extended position. Thus, the computing system secures the object on the vehicle surface.

In one embodiment, a computing system for securing an object on a vehicle surface within a vehicle is disclosed. The computing system includes a processor and memory communicably coupled to the processor. The memory stores instructions that, when executed by the processor, cause the processor to identify a subset of detents in a plurality of detents disposed within the vehicle surface based upon sensor data generated by internal sensors of the vehicle, wherein the sensor data is indicative of dimensions of an object located on the vehicle surface. The instructions further cause the processor to transmit a signal to an actuator of the vehicle, wherein the signal causes the actuator to extend the subset of detents from a non-extended position to an extended position, and wherein the subset of detents conforms to the dimensions of the object when the subset of detents is in the extended position.

In one embodiment, a system for securing an object on a vehicle surface within a vehicle is disclosed. The system comprises the vehicle surface and a plurality of detents disposed within the vehicle surface. The system further comprises an actuator that is configured to apply uniform pressure to the plurality of detents. The uniform pressure extends a subset of detents in the plurality of detents from a non-extended position to an extended position. The subset of detents conforms to dimensions of the object. The system further includes a controller that is configured to transmit a signal to the actuator which causes the actuator to apply the uniform pressure.

In one embodiment, a method is disclosed. The method includes identifying a subset of detents in a plurality of detents disposed within a vehicle surface of a vehicle based upon sensor data generated by internal sensors of the vehicle, wherein the sensor data is indicative of dimensions of an object located on the vehicle surface. The method further includes transmiting a signal to an actuator of the vehicle, wherein the signal causes the actuator to extend the subset of detents from a non-extended position to an extended position, and wherein the subset of detents conform to the dimensions of the object when the subset of detents are in the extended position.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of an object securing system.

FIG. 2 illustrates one embodiment of a vehicle within which systems and methods disclosed herein may be implemented.

FIG. 3 illustrates one embodiment of an object securing system that is associated with securing objects on a vehicle surface within a vehicle.

FIGS. 4A-C illustrate example overhead views of a vehicle surface, a plurality of detents, and an object.

FIGS. 5A-C illustrate side views of a vehicle surface, detents, and an object according to an embodiment.

FIGS. 6A-C illustrate side views of a vehicle surface, detents, and an object according to an embodiment.

FIGS. 7A-C illustrate side views of a vehicle surface, detents, senors, and an object according to an embodiment.

FIGS. 8A-C illustrate side views of a vehicle surface, a flexible covering, detents, and an object according to an embodiment.

FIGS. 9A-C illustrate side views of a vehicle surface, detents, and an object according to an embodiment.

FIG. 10 illustrates a method that is associated with securing an object on a vehicle surface within a vehicle.

### DETAILED DESCRIPTION

Systems, methods, and other embodiments associated with improving securing objects on a surface within a vehicle are disclosed herein. As noted above, conventionally, cargo nets and/or straps may be used to secure objects (e.g., cargo) on a vehicle surface within a vehicle when a vehicle travels about an environment. Cargo nets and/or straps have various deficiencies in securing cargo, such as taking up cabin space of the vehicle when not in use, being aesthetically unappealing, requiring a person to physically place the cargo nets and/or straps over/around the cargo in order to secure the cargo, and being unadaptable to cargo of varying dimensions.

To address these issues, an object securing system (“the system”) is described herein that is configured to secure an object (e.g., cargo) located on a vehicle surface within a vehicle through selective actuation of detents disposed within holes in the vehicle surface. According to embodiments, the detents are pins, rods, or plates. The detents may be of any shape, such as circular, ovular, or polygonal (e.g., square, rectangle, triangular, etc.). In an example, each detent may have a height that ranges from 1 to 30 cm and a radius that ranges from 0.5 to 5 cm. According to embodiments, when the detents are in a non-extended position, the detents remain disposed within the holes in the vehicle surface. When the detents are in an extended position, the detents are raised out of the holes such that the detents conform to dimensions of the object. By selectively actuating detents around the object on the vehicle surface, the object is secured on the vehicle surface.

According to some embodiments, a system comprises a vehicle surface within a vehicle, a plurality of detents disposed within the vehicle surface (e.g., within holes in the vehicle surface), a detent actuator, and a controller. The controller transmits a signal to the detent actuator which causes the detent actuator to apply uniform pressure to the plurality of detents. In an example, the controller activates the detent actuator when the vehicle is turned on. The detent actuator applies the uniform pressure to the plurality of detents in a direction that is generally orthogonal to the vehicle surface and upwards. The uniform pressure causes a first subset of detents in the plurality of detents to extend from a non-extended position to an extended position, where the first subset of detents conforms to dimensions (e.g., a contour) of the object. A weight of the object prevents a second subset of detents in the plurality of detents from extending from the non-extended position to the extended position. For example, the uniform pressure may not be sufficient to change (or substantially change) positions of the second subset of detents. As such, the first subset of detents forms a barrier that prevents the object from moving outside of the barrier due to changes in acceleration of the vehicle and/or due to uneven surfaces traversed by the vehicle. In this manner, the system secures the object on the vehicle surface.

According to some embodiments, the system comprises a computing system of a vehicle. The computing system determines that an object is to be secured on a vehicle surface within an interior of a vehicle. In an example, the object is cargo that is placed within a cargo area of the vehicle, such as a trunk of the vehicle. The vehicle surface has a plurality of detents (e.g., rods, pins, etc.) disposed therein (e.g., disposed within holes in the vehicle surface). Initially, the plurality of detents may be in a non-extended position. According to embodiments, the computing system determines that the object is to be secured on the vehicle surface when the computing system receives an indication that a transmission system of the vehicle has been shifted from a parking gear to a non-parking gear, that the vehicle has been turned turned on, that a button within the vehicle has been pressed, that a door of the vehicle has been closed, or combinations thereof. Responsive to determining that the object is to be secured on the vehicle surface, the computing system identifies a first subset of detents in the plurality of detents based upon sensor data (e.g., images, force, pressure measurements, etc.) generated by internal sensors of the vehicle. The sensor data is indicative of dimensions of the object. The computing system transmits a first signal to a detent actuator of the vehicle. The signal causes the detent actuator to extend the first subset of detents from the non-extended position to the extended position. In an example, the first subset of detents extends 1 to 30 cm above the vehicle surface when in the extended position. A second subset of detents in the plurality of detents is located directly beneath the object on the vehicle surface. The second subset of detents remains in the non-extended position when the first subset of detents is in the extended position. In this manner, the computing system secures the object on the vehicle surface. Subsequently, the computing system determines that it is safe to unsecure the object from the vehicle surface. According to embodiments, the computing system determines that it is safe to unsecure the object from the vehicle surface when the computing system receives a second indication that the transmission system of the vehicle has been shifted from the non-parking gear to the parking gear, that the vehicle has been turned off, that the button within the vehicle has been pressed, that the door of the vehicle has been opened, or combinations thereof. The computing system transmits a second signal to the detent actuator. The signal causes the detent actuator to retract the first subset of detents from the extended position to the non-extended position, thus enabling a person to easily remove the object from the vehicle.

The above-described technologies present various advantages over conventional technologies for securing objects on a vehicle surface within a vehicle. First, by selectively extending detents from a non-extended position to an extended position, the above-described technologies prevent objects from changing positions on the vehicle surface due to acceleration/deceleration of the vehicle and/or due to the vehicle traversing uneven road surfaces. Second, unlike cargo nets and/or straps which take up valuable cabin space of the vehicle, the above-described technologies may ensure that detents remain in a non-extended position when an object is not present on the vehicle surface, thus enabling more space to be available within the vehicle while also not detracting from the aesthetics of the vehicle. Third, according to embodiments, the above-described technologies may automatically extend the detents from the non-extended position to the extended position without receiving manual input from a user (such as by automatically extending the detents when the transmission system of the vehicle is placed into a non-parking gear). Fourth, unlike cargo nets and/or straps which have a fixed sized and may not be able to secure objects of varying dimensions, the above-described technologies are able to secure objects of varying dimensions through selectively actuating detents disposed within the vehicle surface.

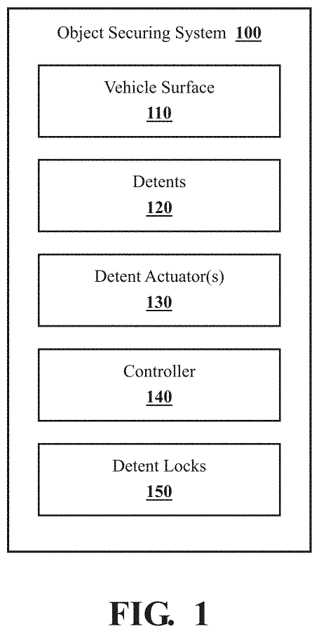

Referring now to FIG. 1, an example object securing system 100 is illustrated. The object securing system 100 may be located within a vehicle. The object securing system 100 comprises a vehicle surface 110 that has a plurality of detents 120 disposed within holes on the surface. The plurality of detents 120 may be arranged in a grid. In an example, a first detent is located within 1 to 5 cm from a second detent in the grid. In an example, the vehicle surface 110 is located within a cargo area of the vehicle, such as a floor of the trunk. In another example, the vehicle surface 110 is a bottom of a cup holder of the vehicle. According to embodiments, the plurality of detents 120 comprise pins, rods, or plates. The plurality of detents 120 may be of any shape, such as circular, ovular, or polygonal (e.g., square, rectangular, triangular, etc.). In an example, a detent in the plurality of detents 120 has a height that ranges from 1 to 50 cm and a radius that ranges from 0.5 to 5 cm. The plurality of detents 120 may be made out of any material, such as a plastic or a metal. A detent in the plurality of detents 120 may be in a non-extended position or an extended position. When in a non-extended position, the detent remains within a respective hole within the vehicle surface 110 such that the combination of the detent and the vehicle surface 110 form a flat surface (or a substantially flat surface). When in the extended position, the detent is extended outside of the respective hole such that the combination of the detent and the vehicle surface 110 form a non-flat surface.

The object securing system 100 includes one or more detent actuators 130 (referred to now herein as “the detent actuator 130”). The detent actuator 130 may be or include an electromechanical acutator, an electromagnetic actuator, a hydraulic actuator, and/or a pneumatic actuator. According to emboodiments, the detent actuator 130 is configured to apply uniform pressure to the plurality of detents 120. For instance, the detent actuator 130 may apply pressure to the plurality of detents 120 in a direction that is orthagonal with respect to the vehicle surface 110 and upwards.

The object securing system 100 may include a controller 140 that controls the detent actuator 130. For instance, the controller 140 may be configured to transmit a signal to the detent actuator 130 that causes the detent actuator 130 to apply the uniform pressure. In an example, the controller 140 is part of a vehicle.

According to embodiments, the object securing system 100 includes detent locks 150 that are configured to lock the plurality of detents 120 in place when the plurality of detents 120 are in the extended position. In an example, the controller 140 transmits a first signal to the detent actuator 130 which causes a detent lock for a detent to lock such that the detent remains in the extended position when uniform pressure is no longer applied to the detent. The detent locks 150 may also be configured to unlock the plurality of detents 120. In an example, the controller 140 transmits a second signal to the detent actuator 130 which causes the detent lock for the detent to unlock such that gravity causes the detent to retract to the non-extended position within a respective hole on the vehicles surface 110.

In an example, an object is located on the vehicle surface 110 and the plurality of detents 120 are initially in the non-extended position. A first subset of detents in the plurality of detents 120 is located around the object on the vehicle surface 110. A second subset of detents in the plurality of detents 120 is located directly beneath the object on the vehicle surface 110, that is, if the second subset of detents were extended from the non-extended position to the extended position, the second subset of detents would make contact with the object. Upon receiving a first signal from the controller 140, the detent actuator 130 applies uniform pressure to the plurality of detents 120 in an upwards direction. In general, the controller 140 controls a level of the uniform pressure such that the uniform pressure is sufficient to extend a detent from the non-extended position to the extended position if the object is not located directly above the detent and such that the uniform pressure is insufficient to extend the detent from the non-extended position to the extendned position if the object is located directly above the detent. The first subset of detents extends from the non-extended position to the extended position due to the uniform pressure applied by the detent actuator 130. A weight of the object prevents the second subset of detents from extending from the non-extended position to the extended position. The first subset of detents conforms to dimensions of the object when in the non-extended position, that is, the first subset of detents prevents the object from moving outside of an area on the vehicle surface 110 due to acceleration/deceleration of the vehicle or due to the vehicle traversing an uneven surface. According to embodiments, the controller 140 locks detent locks for the first subset of detents such that the first subset of detents remains in the extended position when the uniform pressure is no longer applied by the detent actuator 130. According to embodiments, the controller 140 transmits a second signal to the detent actuator 130 which causes the detent actuator 130 to retract the first subset of detents from the extended position to the non-extended position.

According to embodiments, the detent actuator 130 of the object securing system 100 includes mechanical springs that are disposed within each of the plurality of detents 120 or that are coupled to each of the plurality of detents 120. A detent in the plurality of detents 120 is initially locked in a non-extended position. The mechanical spring for the detent is compressed when in the non-extended position. A detent lock in the detent locks 150 prevents the mechanical spring from decompressing when the detent is in the non-extended position. When the detent is pushed down by a person (i.e., when downward force is applied to a top of the detent such that the detent reaches an unlocking position), the detent lock unlocks the mechanical spring, thereby causing the detent to extend from the non-extended position to the extended position due to the decompression of the mechanical spring. This process may be repeated for a subset of detents in the plurality of detents 120 to secure an object on the vehicle surface 110. When the person wishes to unsecure the object, the person may push the detent downwards from the extended position to the non-extended position, thereby compressing the mechanical spring for the detent. The detent lock for the detent locks the mechanical spring in the non-extended position. This process may be repeated for the subset of detents in the plurality of detents 120 to unsecure the object on the vehicle surface 110.

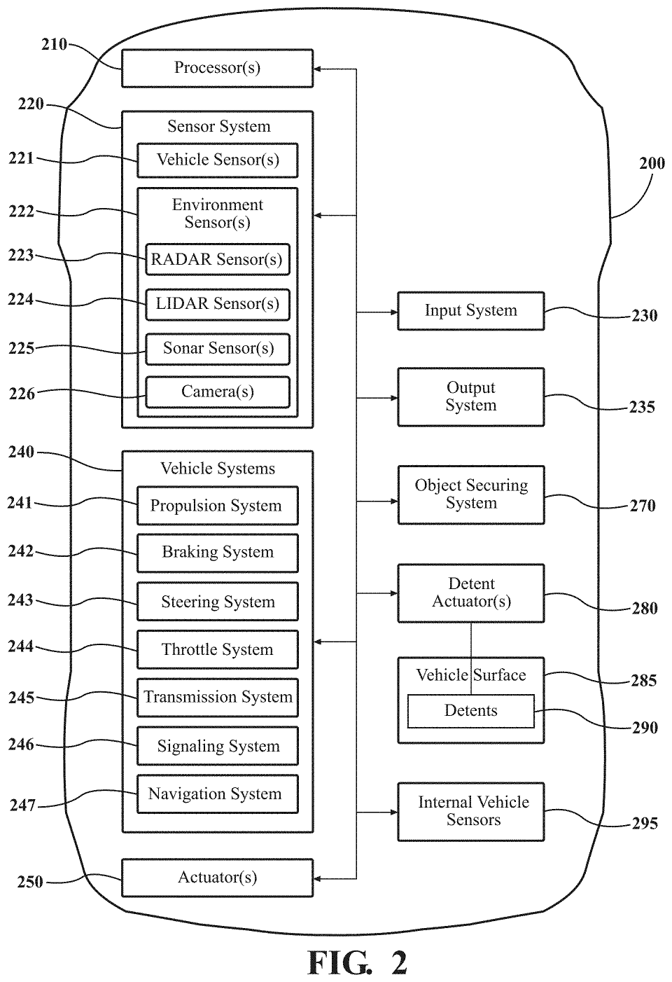

Referring to FIG. 2, an example of a vehicle 200 is illustrated. As used herein, a “vehicle” is any form of motorized transport. In one or more implementations, the vehicle 200 is an automobile. While arrangements will be described herein with respect to automobiles, it will be understood that embodiments are not limited to automobiles. In some implementations, the vehicle 200 may be any robotic device or form of motorized transport that benefits from the functionality discussed herein associated with securing objects.

The vehicle 200 also includes various elements. It will be understood that in various embodiments it may not be necessary for the vehicle 200 to have all of the elements shown in FIG. 2. The vehicle 200 can have any combination of the various elements shown in FIG. 2. Further, the vehicle 200 can have additional elements to those shown in FIG. 2. In some arrangements, the vehicle 200 may be implemented without one or more of the elements shown in FIG. 2. While the various elements are shown as being located within the vehicle 200 in FIG. 2, it will be understood that one or more of these elements can be located external to the vehicle 200. Further, the elements shown may be physically separated by large distances. For example, as discussed, one or more components of the disclosed system can be implemented within the vehicle 200 while further components of the system are implemented within a cloud-computing environment or other system that is remote from the vehicle 200.

Some of the possible elements of the vehicle 200 are shown in FIG. 2 and will be described along with subsequent figures. However, a description of many of the elements in FIG. 2 will be provided after the discussion of FIGS. 2-10 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, the vehicle 200 includes an object securing system 270 that is implemented to perform methods and other functions as disclosed herein relating to improving securing an object located on a vehicle surface in an interior of the vehicle 200.

The vehicle 200 includes one or more detent actuators 280 (referred to now herein as “the detent actuator 280”). The detent actuator 280 may be or include the detent actuators 130 described above.

The vehicle 200 also includes a vehicle surface 285 that has a plurality of detents 290 disposed therein (e.g., disposed within holes in the vehicle surface 285). The vehicle surface 285 is located in an interior of the vehicle 200. The plurality of detents 290 may be or include the plurality of detents 120 described above. The vehicle 200 may also include the detent locks 150 described above (not illustrated in FIG. 2).

According to embodiments, the vehicle 200 includes internal vehicle sensors 295 (also referred to herein as “the internal sensors 295 of the vehicle 200”). In general, the internal vehicle sensors 295 are configured to generate sensor data that is indicative of dimensions of an object located on the vehicle surface 285. The internal vehicle sensors 295 may also be configured to generate sensor data that is indicative of a presence or absence of the object on the vehicle surface 285. The internal vehicle sensors 295 may include one or more cameras that capture one or more images of the object, one or more pressure sensors that generate measurements of pressure, one or more force sensors that generate measurements of force, one or more optical sensors, and/or one or more mechanical switches that are tripped when making contact with a detent. According to embodiments, the one or more cameras include one or more time of flight (TOF) cameras. According to embodiments, some or all of the internal vehicle sensors 295 are coupled to or integrated into the plurality of detents 290.

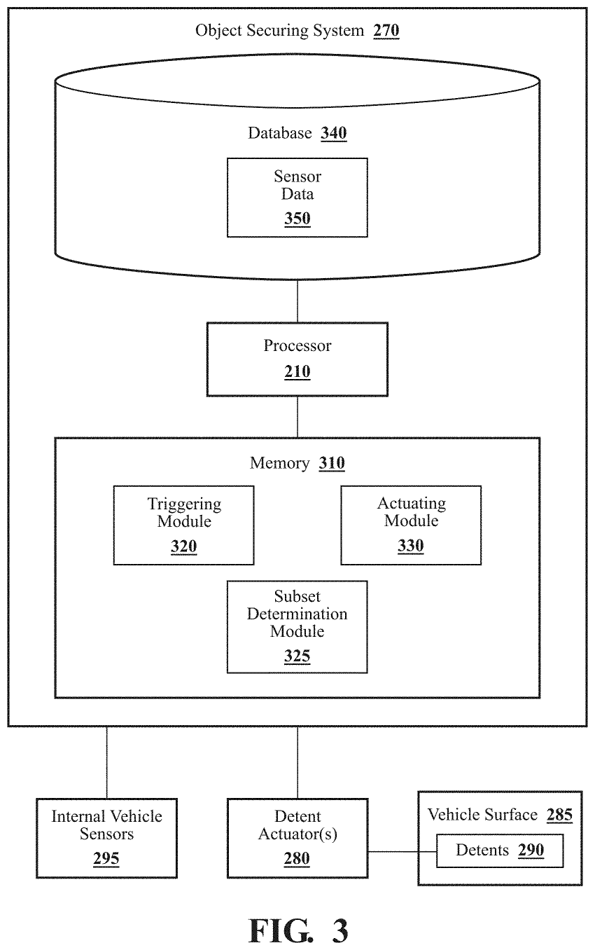

With reference to FIG. 3, one embodiment of the object securing system 270 of FIG. 2 is further illustrated. The object securing system 270 is shown as including a processor 210 from the vehicle 200 of FIG. 2. Accordingly, the processor 210 may be a part of the object securing system 270, the object securing system 270 may include a separate processor from the processor 210 of the vehicle 200, or the object securing system 270 may access the processor 210 through a data bus or another communication path. In one embodiment, the object securing system 270 includes a memory 310 that stores a triggering module 320, a subset determination module 325, and an actuating module 330. The memory 310 is a random-access memory (RAM), read-only memory (ROM), a hard-disk drive, a flash memory, or other suitable memory for storing the triggering module 320, the subset determination module 325, and the actuating module 330. The triggering module 320, the subset determination module 325, and the actuating module 330 are, for example, computer-readable instructions that when executed by the processor 210 cause the processor 210 to perform the various functions disclosed herein. The object securing system 270 is in communication with the detent actuators 280. The object securing system 270 may be in communication with the internal vehicle sensors 295.

The triggering module 320 generally includes instructions that function to control the processor 210 to receive data inputs from the vehicle sensors 221, the environment sensors 222, the vehicle systems 240, the input system 230, and/or the internal vehicle sensors 295. In general, the triggering module 320 is configured to determine that an object located on the vehicle surface 285 is to be secured on the vehicle surface 285 (described in greater detail below). In general, the triggering module 320 is also configured to determine that it is safe to unsecure the object on the vehicle surface 285 (described in greater detail below).

The subset determination module 325 generally includes instructions that function to control the processor 210 to receive data inputs from the triggering module 320. In general, the subset determination module 325 is configured to identify a subset of detents in the plurality of detents 290 that are to be extended from a non-extended position to an extended position based upon sensor data 350 responsive to receiving an indication from the triggering module 320 (described in greater detail below). According to embodiments, the subset determination module 325 is also configured to determine a height of the object based upon the sensor data 350.

According to embodiments, subset determination module 325 may be or include a machine learning model that is configured to determine dimensions of an object on the vehicle surface 285 based upon the sensor data 350. For instance, the machine learning model may be configured to identify dimensions of the object based upon one or more images of the object captured by a camera.

The actuating module 330 generally includes instructions that function to control the processor 210 to transmit receive data from triggering module 320 and the subset determination module 325. In general, the actuating module 330 is configured to transmit a first signal to the detent actuators 280 that causes the detent actuator 280 to extend the subset of detents from a non-extended position to an extended position responsive to receiving data from the subset determination module 325, where the data is indicative of identities of the subset of detents. In general, the actuating module 330 may also be configured to transmit a second signal to the detent actuators 280 that causes the detent actuators 280 to retract the subset of detents from the extended position to the non-extended position responsive to receiving data from the triggering module 320.

Moreover, in one embodiment, the object securing system 270 includes a database 340. The database 340 is, in one embodiment, an electronic data structure stored in the memory 310 or another data store and that is configured with routines that can be executed by the processor 210 for analyzing stored data, providing stored data, organizing stored data, and so on. Thus, in one embodiment, the database 340 stores data used by the triggering module 320, the subset determination module 325, and/or the actuating module 330 in executing various functions.

In one embodiment, the database 340 further includes the sensor data 350. The sensor data 350 is generated by the vehicle sensors 221, the environment sensors 222, and/or the internal vehicle sensors 295. According to embodiments, the sensor data 350 includes an image of the object on the vehicle surface 285, force measurements, or pressure measurements.

Example operation of the object securing system 270 is now set forth. It is contemplated that an object is placed on the vehicle surface 285 and that the plurality of detents 290 are initially in the non-extended position. In an example, the vehicle surface 285 is located in a cargo area of the vehicle 200, such as a floor of a trunk of the vehicle 200. In another example, the vehicle surface 285 is located on a floor of a cabin of the vehicle 200. In a further example, the vehicles surface 285 is a bottom of a cup holder of the vehicle 200.

The triggering module 320 determines that the object is to be secured on the vehicle surface 285. According to embodiments, the triggering module 320 determines that the object is to be secured on the vehicle surface 285 upon receiving an indication that the transmission system 245 has been shifted from a parking gear to a non-parking gear. According to some embodiments, the triggering module 320 determines that the object is to be secured on the vehicle surface 285 upon receiving an indication that a door of the vehicle 200 is closed, such as a door to a cargo area of the vehicle 200. According to some embodiments, the triggering module 320 determines that the object is to be secured on the vehicle surface 285 upon receiving an indication that a button within the vehicle 100 has been pressed (e.g., by an operator of the vehicle 200, a passenger of the vehicle 200, etc.). According to embodiments, the triggering module 320 determines that the object is to be secured on the vehicle surface 285 upon receiving an indication that the vehicle 200 has been turned on.

Upon receiving an indication from the triggering module 320, the subset determination module 325 identifies a first subset of detents in the plurality of detents 290 based upon the sensor data 350, where some or all of the sensor data 350 is generated by the internal vehicle sensors 295. The sensor data 350 is indicative of dimensions of the object on the vehicles surface 285. The first subset of detents conforms to the dimensions of the object. A second subset of detents in the plurality of detents 290 is located directly beneath the object on the vehicle surface 285. The second subset of detents may or may not be in contact with the object on the vehicle surface 285. In an example, the first subset of detents encloses the object in an area on the vehicle surface 285. The first subset of detents is located outside of the area. The second subset of detents is located inside the area.

According to embodiments, the internal vehicle sensors 295 include one or more pressure sensors and the sensor data 350 comprises a plurality of pressure measurements for the plurality of detents 290. A pressure measurement is indicative of an amount of pressure applied to a detent in the plurality of detents 290. A pressure measurement may be a zero value or a non-zero value. The triggering module 320 compares a pressure measurement for a detent to a threshold value. When the pressure measurement for the detent is less than or equal to the threshold value, the subset determination module 325 identifies the detent as being in the first subset. When the pressure measurement for the detent is greater than the threshold value (e.g., due to a weight of the object on the detent), the subset determination module 325 identifies the detent as being in the second subset of detents.

According to embodiments, the internal vehicle sensors 295 include one or more force sensors and the sensor data 350 comprises a plurality of force measurements for the plurality of detents 290. A force measurement is indicative of an amount of force applied to a detent in the plurality of detents 290. A force measurement may be a zero value or a non-zero value. The subset determination module 325 compares a force measurement for a detent to a threshold value. When the force measurement is less than or equal to the threshold value, the subset determination module 325 identifies the detent as being in the first subset of detents. When the pressure measurement is greater than the threshold value (e.g., due to a weight of the object on the detent), subset determination module 325 identifies the detent as being in the second subset of detents.

According to embodiments, the internal vehicle sensors 295 include one or more cameras and the sensor data 350 comprises an image (or images) of the object on the vehicle surface 285. The subset determination module 325 determines an area on the vehicle surface 285 that is occupied by the object based upon the image of the object (e.g., using a machine learning model that is configured to identify boundaries of objects). The subset determination module 325 identifies the first subset of detents based upon the area.

According to embodiments, the internal vehicle sensors 295 include optical sensors. An optical sensor for a detent comprises an emitter that is disposed within the detent and a receiver that is disposed within a roof of the vehicle. The emitter emits light (e.g., infrared light) in an upwards direction toward the receiver. When the object is placed over the emitter on the detent, the receiver generates data indicating that the receiver is no longer receiving the light from the emitter. The subset determination module 325 identifies the second subset of detents based upon the data generated by the optical sensors. The subset determination module 325 identifies the first subset of detents based upon identifying second subset of detents. For instance, the subset determination module 325 selects detents that are adjacent to the second subset of detents.

According to embodiments, the subset determination module 325 identifies the second subset of detents (e.g., using an image, using pressure measurements, etc.) based upon the sensor data 350. The subset determination module 325 then identifies the first subset of detents based upon the second subset of detents. For instance, the subset determination module 325 may access a map that includes locations of the plurality of detents 290. The subset determination module 325 identifies locations of the second subset of detents in the map based upon the sensor data 350. The subset determination module 325 then identifies the first subset of detents by selecting detents located adjacent to the second subset of detents in the map.

The actuating module 330 receives data that is indicative of identities of the first subset of detents from the subset determination module 325. The actuating module 330 transmits a signal to the detent actuator 280 based upon the data. The signal causes the detent actuator 280 to apply force to the first subset of detents, where the force is applied in an upwards direction (e.g., towards a roof of the vehicle 200). In an example, the force is applied in a direction that is orthogonal to the vehicle surface 285. The force causes the first subset of detents to extend from a non-extended position to an extended position. In an example, the first subset of detents extends 1 to 50 cm above the vehicle surface 285 when in the extended position. In an example, a distance between a side of a detent in the first subset and a side of the object ranges from 0 to 5 cm.

The first subset of detents encloses the object in an area on the vehicle surface 285 when the first subset of detents is in the extended position. For instance, the object may have a first surface and a second surface, where the first surface makes contact with the vehicle surface 285. When the vehicle 200 undergoes a change in acceleration (or travels over an uneven surface) when the first subset of detents are in the extended position, the second surface of the object makes contact with a side of one or more detents in the first subset of detents, thus preventing the object from moving outside of the area.

According to embodiments, the plurality of detents 290 further includes a third subset of detents in addition to the first subset of detents and the second subset of detents. The third subset of detents are located outside of the area enclosed by the first subset of detents. The third subset of detents remains in the non-extended position when the first subset of detents is in the extended position.

According to embodiments, subset determination module 325 determines a height of the object based upon the sensor data 350. The subset determination module 325 determines a degree to which the first subset of detents is to be extended based upon the height of the object.

Subsequent to the first subset of detents being extended from the non-extended position to the extended position, it is contemplated that the object is to be unsecured on the vehicle surface 285. For instance, the vehicle 200 may arrive at a destination and an occupant of the vehicle may want to unload the object from the vehicle 200. According to embodiments, the triggering module 320 determines that it is safe to unsecure the object from the vehicle surface 285. According to embodiments, the triggering module 320 determines that it is safe to unsecure the object on the vehicle surface 285 upon receiving an indication that the transmission system 245 of the vehicle 200 has been shifted from the non-parking gear to the parking gear. According to some embodiments, the triggering module 320 determines that it is safe to unsecure the object on the vehicle surface 285 upon receiving an indication that a door of the vehicle 200 has been opened, such as the door to the cargo area of the vehicle 200. According to some embodiments, the triggering module 320 determines that it is safe to unsecure the object on the vehicle surface 285 upon receiving an indication that the button within the vehicle 200 has been pressed. According to embodiments, the triggering module 320 determines that it is safe to unsecure the object on the vehicle surface 285 upon receiving an indication that the vehicle 200 has been turned off/is being turned off.

According to embodiments, the triggering module 320 transmits an indication to the actuating module 330. Responsive to receiving the indication, the actuating module 330 transmits a signal to the detent actuator 280 which causes the detent actuator 280 to retract the first subset of detents from the extended position to the non-extended position. According to embodiments, the detent actuator 280 unlocks detent locks of the first subset of detents and gravity causes the first subset of detents to retract from the extended position to the non-extended position. According to other embodiments, the detent actuator 280 applies force to the first subset of detents in a downwards direction to retract the first subset of detents from the extended position to the non-extended position. The object may then be easily removed from the vehicle surface 285

According to embodiments, the object securing system 270 may be or include the object securing system 100.

Although the object securing system 100 and the object securing system 270 have been described above as securing a single object on the vehicle surface 285, it is to be understood that the object securing system 100 and the object securing system 270 may secure multiple objects on the vehicle surface at the same time by selecting actuating detents as described above.

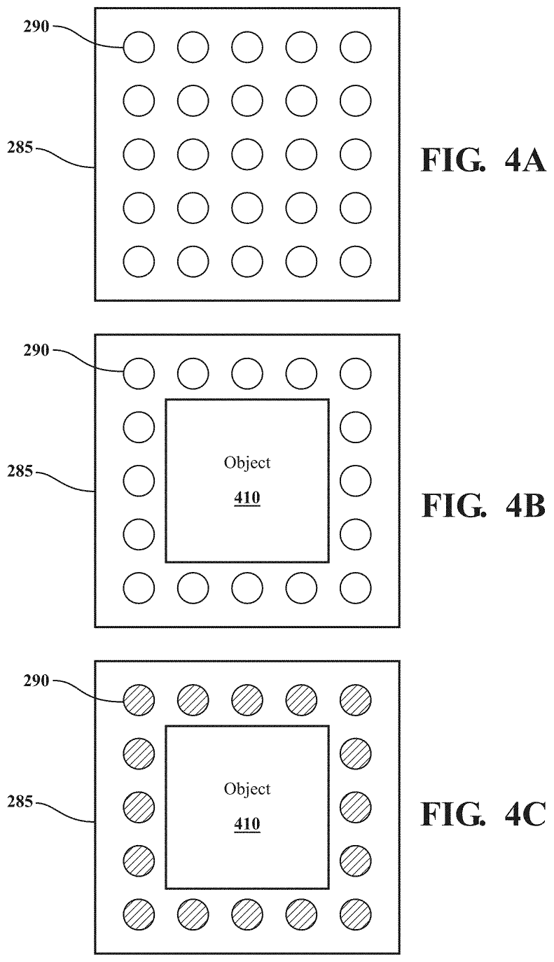

FIGS. 4A-C illustrate example overhead views of the vehicle surface 285 and the plurality of detents 290 (indicated by circles). Refering to FIG. 4A, an overhead view of the vehicle surface 285 and the plurality of detents 290 is illustrated. In an example, the vehicle surface 285 is a floor of a trunk of the vehicle 200. Although the detents are illustrated as being circular, the plurality of detents 290 may be of any shape (e.g., square, rectangular, etc.). The plurality of detents 290 are are in a non-extended position (indicated by white filling of the circles). It is to be understood that the vehicles surface 285 may include additional detents other than the plurality of detents 290 illustrated in FIG. 4A.

Referring now to FIG. 4B, an object 410 is placed on the vehicle surface 285 (which includes the plurality of detents 290 in a non-extended position). The detents 290 include a first subset of detents illustrated by visible circles in FIG. 4B and a second subest of detents which are covered by the object 410 and hence are not visible in FIG. 4B.

Referring now to FIG. 4C, using the above-described processes, the object securing system 270 extends the first subset of detents from the non-extended position to the extended position (indicated by circles with diagonal lines in FIG. 4C), thereby securing the object 410 on the vehicle surface 285. The object securing system 270 does not extend the second subset of detents from the non-extended position to the extended position.

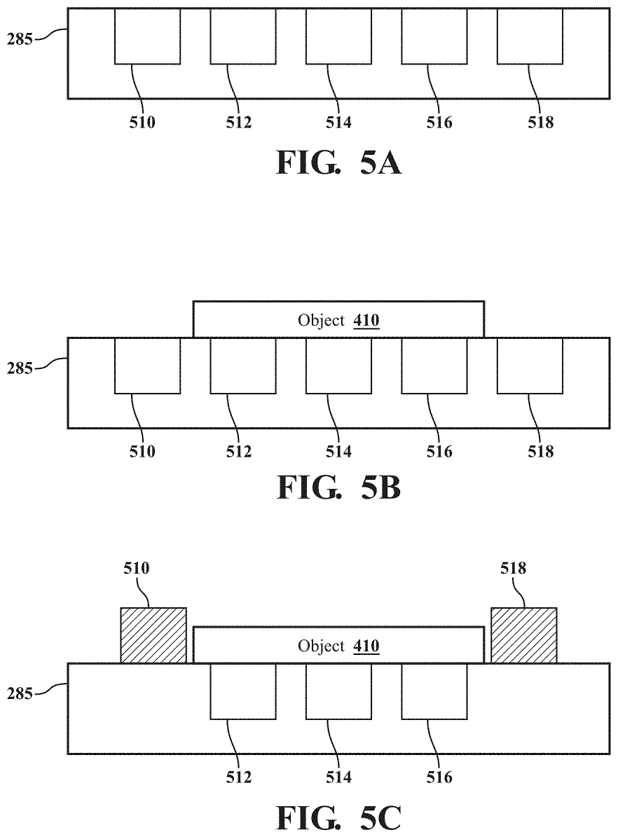

FIGS. 5A-C illustrate side views of the vehicle surface 285 according to an embodiment. Referring to FIG. 5A, a side view of the vehicle surface 285 is illustrated. The sideview depicts a first detent 510, a second detent 512, a third detent 514, a fourth detent 516, and a fifth detent 518 (collectively, “the detents 510-518”). In an example, the detents 510-518 are included in the plurality of detents 290. In FIG. 5A, the detents 510-518 are in a non-extended position, that is, disposed within holes within the vehicles surface 285. In the embodiment depicted in FIG. 5A, the detents 510-518 and the vehicle surface 285 form a flat surface when the detents 510-518 are in the non-extended position.

Referring to FIG. 5B, the object 410 is placed on the vehicle surface 285. The object 410 is located directly above the second detent 512, the third detent 514, and the fourth detent 516. The first detent 510 and the fifth detent 518 are located around the object 410.

Referring now to FIG. 5C, using the above-described processes, the object securing system 270 extends the first detent 510 and the fifth detent 518 from the non-extended position to the extended position. In an example, the first detent 510 and the fifth detent 518 are part of the first subset of detents discussed in FIGS. 4A-C. In an example, the second detent 512, the third detent 514, and the fourth detent 516 are part of the second subset of detents discussed in FIGS. 4A-C and as a result the object securing system 270 does not extend the second detent 512, the third detent 514, and the fourth detent 516 from the non-extended position to the extended position.

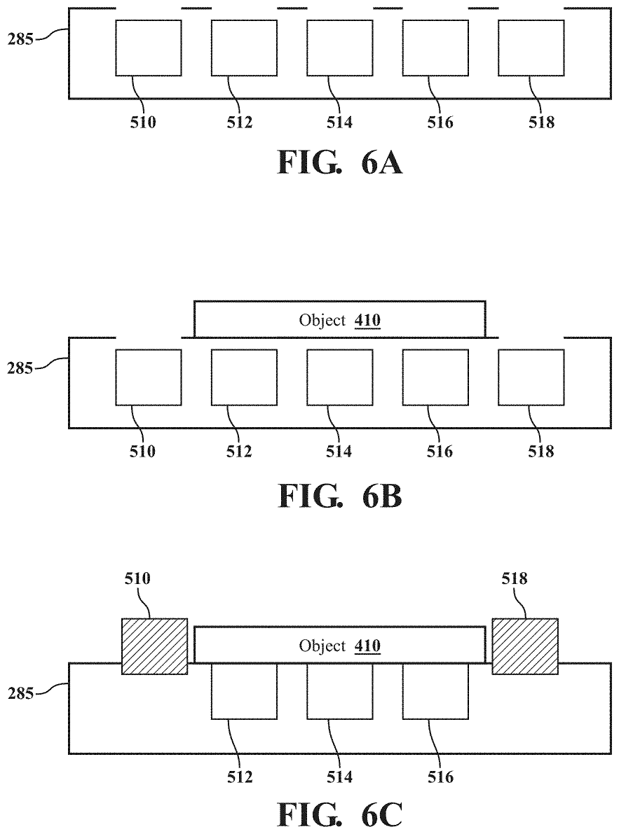

FIGS. 6A-C illustrate side views of the vehicle surface 285 according to an embodiment. Referring to FIG. 6A, a side view of the vehicle surface 285 is illustrated. The sideview depicts the detents 510-518 described above. In the embodiment illustrated in FIG. 6A, the detents 510-518 are positioned below a top of the vehicle surface 285 when in the non-extended position.

Referring now to FIG. 6B, the object 410 is placed on the vehicle surface 285. The object 410 is located directly above the second detent 512, the third detent 514, and the fourth detent 516. The first detent 510 and the fifth detent 518 are located around the object 410.

Referring now to FIG. 6C, using the above-described processes, the object securing system 270 extends the first detent 510 and the fifth detent 518 from the non-extended position to the extended position. In an example, the first detent 510 and the fifth detent 518 are part of the first subset of detents discussed in FIGS. 4A-C. In an example, the second detent 512, the third detent 514, and the fourth detent 516 are part of the second subset of detents discussed in FIGS. 4A-C and as a result the object securing system 270 does not extend the second detent 512, the third detent 514, and the fourth detent 516 from the non-extended position to the extended position. In the example depicted in FIG. 6C, the first detent 510 and the fifth detent 518 are partially extended when in the extended position, that is, a first portion of the first detent 510 and the fifth detent 518 remain within the vehicle surface 285 while a second portion of the first detent and the fifth detent 518 are extended outside of the vehicle surface 285. A degree to which the first detent 510 and the fifth detent 518 are extended may be based upon a height of the object 410.

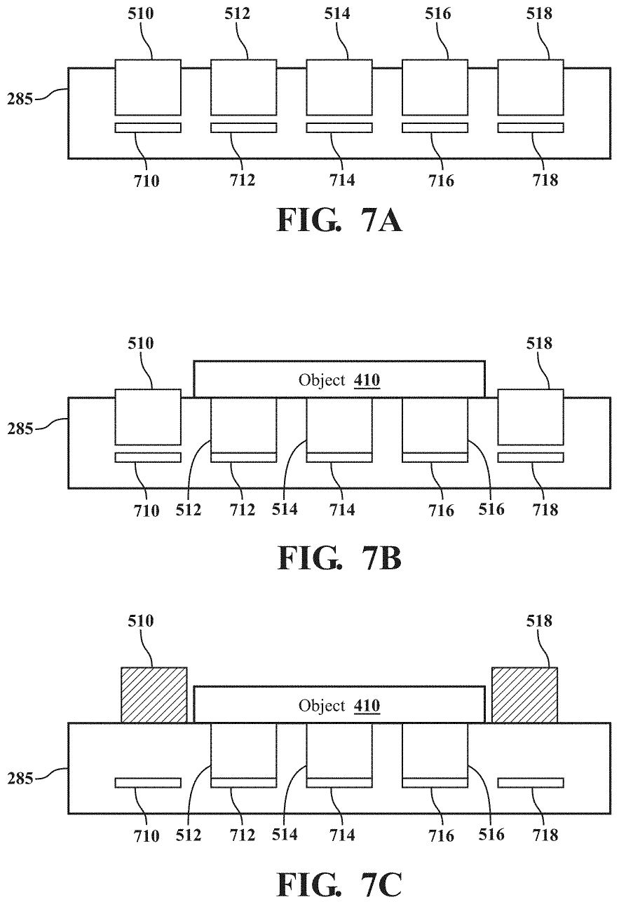

FIGS. 7A-C illustrate side views of the vehicle surface 285 according to an embodiment. Referring to FIG. 7A, a sideview of the vehicle surface 285 is illustrated. The sideview depicts the detents 510-518 described above. In the embodiment illustrated in FIG. 7A, a portion of each of the detents 510-518 are located outside of the vehicle surface 285 when the the detents are in the non-extended position. In the embodiment illustrated in FIG. 7A, a first sensor 710, a second sensor 712, a third sensor 714, a fourth sensor 716, and a fifth sensor 718 (collectively “the sensors 710-718”) are located beneath the first detent 510, the second detent 512, the third detent 514, the fourth detent 516, and the fifth detent 518. The sensors 710-718 may be part of the internal vehicle sensors 295. The sensors 710-718 may be force sensors or pressure sensors. The sensors 710-718 may also be mechanical switches.

Referring now to FIG. 7B, the object 410 is placed on the vehicle surface 285. The object 410 is located directly above the second detent 512, the third detent 514, and the fourth detent 516. The first detent 510 and the fifth detent 518 are located around to the object 410. According to embodiments, the detents 510-518 are compressible. As such, a weight of the object 410 causes the second detent 512, the third detent 514, and the fourth detent 516 to move downwards into the vehicle surface 285. The second detent 512, the third detent 514, and the fourth detent 516 make contact with the second sensor 712, the third sensor 714, and the fourth sensor 716, respectively. Accoording to embodiments, the object securing system 270 selects the second detent 512, the third detent 514, and the fourth detent 516 as being in the second subset of detents based upon data output by the second sensor 712, the third sensor 714, and the fourth sensor 716 when the second sensor 712, the third sensor 714, and the fourth sensor 716 make contact with the second detent 512, the third detent 514, and the fourth detent 516, respectively. The object securing system 270 selects the first detent 510 and the fifth detent 518 as being part of the first subset of detents based upon the first detent 510 and the fifth detent 518 being adjacent to the second detent 512 and the fourth detent 516.

Referring now to FIG. 7C, using the above-described processes, the object securing system 270 extends the first detent 510 and the fifth detent 518 from the non-extended position to the extended position. In an example, the first detent 510 and the fifth detent 518 are part of the first subset of detents discussed in FIGS. 4A-C. In an example, the second detent 512, the third detent 514, and the fourth detent 516 are part of the second subset of detents discussed in FIGS. 4A-C and as a result the object securing system 270 does not extend the second detent 512, the third detent 514, and the fourth detent 516 from the non-extended position to the extended position.

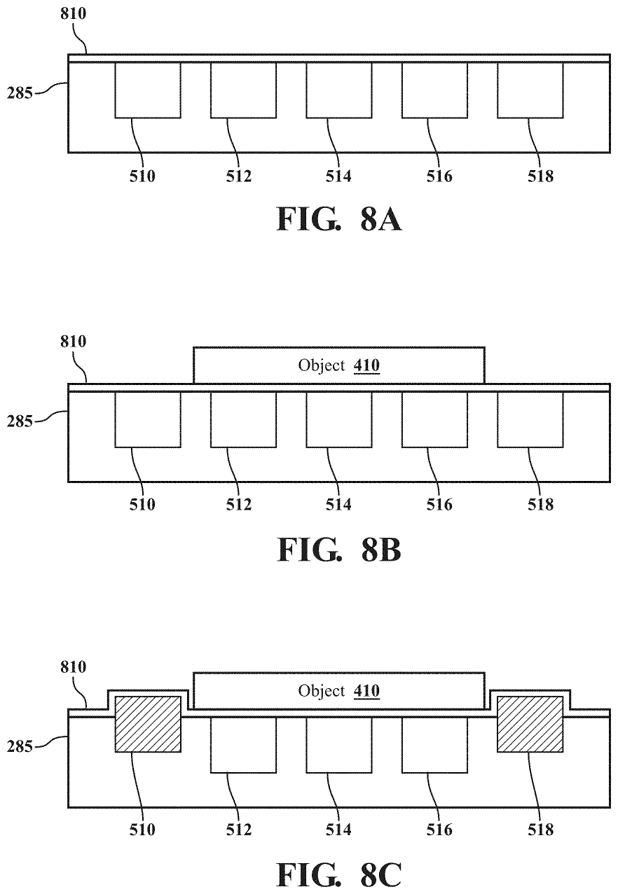

FIGS. 8A-C illustrate side views of the vehicle surface 285 according to an embodiment. Referring to FIG. 8A, a side view of the vehicle surface 285 is illustrated. The sideview depicts the detents 510-518 described above. Accoording to the embodiment depicted in FIG. 8A, a flexible covering 810 covers the vehicle surface 285. In an example, the flexible covering 810 is made of a cloth or a polymer.

Referring now to FIG. 8B, the object 410 is placed on the flexible covering 810 on the vehicle surface 285. The object 410 is located directly above the second detent 512, the third detent 514, and the fourth detent 516. The first detent 510 and the fifth detent 518 are located around the object 410.

Referring now to FIG. 8C, using the above-described processes, the object securing system 270 extends the first detent 510 and the fifth detent 518 from the non-extended position to the extended position. In an example, the first detent 510 and the fifth detent 518 are part of the first subset of detents discussed in FIGS. 4A-C. In an example, the second detent 512, the third detent 514, and the fourth detent 516 are part of the second subset of detents discussed in FIGS. 4A-C and as a result the object securing system 270 does not extend the second detent 512, the third detent 514, and the fourth detent 516 from the non-extended position to the extended position. According to the embodiment depicted in FIG. 8C, the extension of the first detent 510 and the fifth detent 518 causes the flexible covering 810 to bend to conform to the dimensions of the first detent 510 and the fifth detent 518.

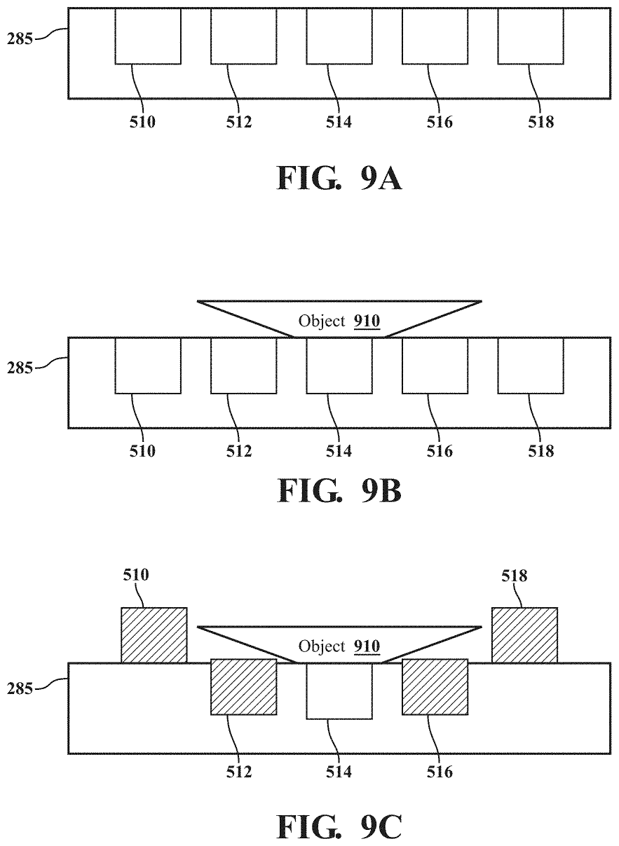

FIGS. 9A-C illustrate side views of the vehicle surface 285 according to an embodiment. Referring to FIG. 9A, a sideview of the vehicle surface 285 is illustrated. The sideview depicts the detents 510-518 described above.

Referring now to FIG. 9B, an object 910 is placed on the vehicle surface 285. The object 910 is located directly above the second detent 512, the third detent 514, and the fourth detent 516. The first detent 510 and the fifth detent 518 are located around to the object 410.

Referring now to FIG. 9C, using the above-described processes, the object securing system 270 extends the first detent 510 and the fifth detent 518 from the non-extended position to a first extended position based upon the sensor data 350, where the object securing system 270 determines the first extended position based upon the dimensions of the object 910. The object securing system 270 extends the second detent 512 and the fourth detent 516 from the non-extended position to a second extended position based upon the sensor data 350, where the object securing system 270 determines the second extended position based upon the dimensions of the object 910. In an example, the first detent 510, the second detent 512, the fourth detent 516, and the fifth detent 518 are part of the first subset of detents. In an example, the third detent 514 is part of the second subset of detents. The object securing system 270 does not extend the third detent 514.

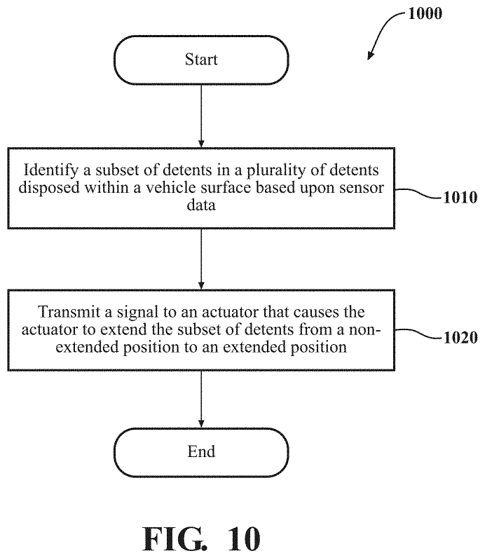

Additional aspects of the object securing system 270 will be discussed in relation to FIG. 10. FIG. 10 illustrates a flowchart of a method 1000 that is associated with securing an object on the vehicle surface 285 of the vehicle 200. Method 1000 will be discussed from the perspective of the object securing system 270 of FIGS. 2 and 3. While method 1000 is discussed in combination with the object securing system 270, it should be appreciated that the method 1000 is not limited to being implemented within the object securing system 270 but is instead one example of a system that may implement the method 1000.

At 1010, the object securing system 270 identifies a subset of detents in the plurality of detents 290 disposed within the vehicle surface 285 of the vehicle 200 based upon the sensor data 350 generated by the internal vehicle sensors 295 of the vehicle 200. The sensor data 350 is indicative of dimensions of an object on the vehicle surface 285. According to some embodiments, the object securing system 270 receives an indication that a button within the vehicle 200 has been pressed and the object securing system 270 identifies the subset of detents responsive to receiving the indication. According to some embodiments, identifying the subset of detents includes receiving an image of the object on the vehicle surface 285, determining an area on the vehicle surface 285 that is occupied by the object based upon the image, and selecting the subset of detents based upon the area, where the subset of detents is located outside of the area.

At 1020, the object securing system 270 transmits a signal to the detent actuator 280 of the vehicle 200. The signal causes the detent actuator 280 to extend the subset of detents from a non-extended position to an extended position. The subset of detents conforms to the dimensions of the object when the subset of detents is in the extended position. In an example, the detent actuator 280 extends the subset of detents in an upwards direction. When the subset of detents is in the extended position, the object is secured on the vehicle surface 285 when the vehicle 200 undergoes a change in acceleration. According to some embodiments, the method further includes determining a height of the object based upon sensor data, where a degree to which the subset of detents is extended in the extended position is based upon the height of the object.

FIG. 2 will now be discussed in full detail as an example environment within which the system and methods disclosed herein may operate. In some instances, the vehicle 200 is configured to switch selectively between an autonomous mode, one or more semi-autonomous operational modes, and/or a manual mode. Such switching can be implemented in a suitable manner, now known or later developed. “Manual mode” means that all of or a majority of the navigation and/or maneuvering of the vehicle is performed according to inputs received from a user (e.g., human driver). In one or more arrangements, the vehicle 200 can be a conventional vehicle that is configured to operate in only a manual mode.

In one or more embodiments, the vehicle 200 is an autonomous vehicle. As used herein, “autonomous vehicle” refers to a vehicle that operates in an autonomous mode. “Autonomous mode” refers to navigating and/or maneuvering the vehicle 200 along a travel route using one or more computing systems to control the vehicle 200 with minimal or no input from a human driver. In one or more embodiments, the vehicle 200 is highly automated or completely automated. In one embodiment, the vehicle 200 is configured with one or more semi-autonomous operational modes in which one or more computing systems perform a portion of the navigation and/or maneuvering of the vehicle along a travel route, and a vehicle operator (i.e., driver) provides inputs to the vehicle 200 to perform a portion of the navigation and/or maneuvering of the vehicle 200 along a travel route.

The vehicle 200 can include one or more processors 210. In one or more arrangements, the processor(s) 210 can be a main processor of the vehicle 200. For instance, the processor(s) 210 can be an electronic control unit (ECU).

As noted above, the vehicle 200 can include the sensor system 220. The sensor system 220 can include one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

The sensor system 220 can include any suitable type of sensor. Various examples of different types of sensors will be described herein. However, it will be understood that the embodiments are not limited to the particular sensors described. The sensor system 220 can include one or more vehicle sensors 221. The vehicle sensor(s) 221 can detect, determine, and/or sense information about the vehicle 200 itself. In one or more arrangements, the vehicle sensor(s) 221 can be configured to detect, and/or sense position and orientation changes of the vehicle 200, such as, for example, based on inertial acceleration. In one or more arrangements, the vehicle sensor(s) 221 can include one or more accelerometers, one or more gyroscopes, an inertial measurement unit (IMU), a dead-reckoning system, a global navigation satellite system (GNSS), a global positioning system (GPS), a navigation system 247, and/or other suitable sensors. The vehicle sensor(s) 221 can be configured to detect, and/or sense one or more characteristics of the vehicle 200. In one or more arrangements, the vehicle sensor(s) 221 can include a speedometer to determine a current speed of the vehicle 200.

Alternatively, or in addition, the sensor system 220 can include one or more environment sensors 222 configured to acquire, and/or sense driving environment data. “Driving environment data” includes data or information about the external environment in which an autonomous vehicle is located or one or more portions thereof. For example, the one or more environment sensors 222 can be configured to detect, quantify and/or sense obstacles in at least a portion of the external environment of the vehicle 200 and/or information/data about such obstacles. Such obstacles may be stationary objects and/or dynamic objects. The one or more environment sensors 222 can be configured to detect, measure, quantify and/or sense other things in the external environment of the vehicle 200, such as, for example, lane markers, signs, traffic lights, traffic signs, lane lines, crosswalks, curbs proximate the vehicle 200, off-road objects, etc.

Various examples of sensors of the sensor system 220 will be described herein. The example sensors may be part of the one or more environment sensors 222 and/or the one or more vehicle sensors 221. However, it will be understood that the embodiments are not limited to the particular sensors described.

As an example, in one or more arrangements, the sensor system 220 can include one or more radar sensors 223, one or more LIDAR sensors 224, one or more sonar sensors 225, and/or one or more cameras 226. In one or more arrangements, the one or more cameras 226 can be high dynamic range (HDR) cameras or infrared (IR) cameras.

The vehicle 200 can include an input system 230. An “input system” includes any device, component, system, element or arrangement or groups thereof that enable information/data to be entered into a machine. The input system 230 can receive an input from a vehicle passenger (e.g., a driver or a passenger). The vehicle 200 can include an output system 235. An “output system” includes any device, component, or arrangement or groups thereof that enable information/data to be presented to a vehicle passenger (e.g., a person, a vehicle passenger, etc.).

The vehicle 200 can include one or more vehicle systems 240. Various examples of the one or more vehicle systems 240 are shown in FIG. 2. However, the vehicle 200 can include more, fewer, or different vehicle systems. It should be appreciated that although particular vehicle systems are separately defined, each or any of the systems or portions thereof may be otherwise combined or segregated via hardware and/or software within the vehicle 200. The vehicle 200 can include a propulsion system 241, a braking system 242, a steering system 243, throttle system 244, a transmission system 245, a signaling system 246, and/or a navigation system 247. Each of these systems can include one or more devices, components, and/or a combination thereof, now known or later developed.

The navigation system 247 can include one or more devices, applications, and/or combinations thereof, now known or later developed, configured to determine the geographic location of the vehicle 200 and/or to determine a travel route for the vehicle 200. The navigation system 247 can include one or more mapping applications to determine a travel route for the vehicle 200. The navigation system 247 can include a global positioning system, a local positioning system or a geolocation system.

The vehicle 200 can include one or more actuators 250. The actuators 250 can be any element or combination of elements operable to modify, adjust and/or alter one or more of the vehicle systems 240 or components thereof to responsive to receiving signals or other inputs from the processor(s) 210. Any suitable actuator can be used. For instance, the one or more actuators 250 can include motors, pneumatic actuators, hydraulic pistons, relays, solenoids, and/or piezoelectric actuators, just to name a few possibilities.

The vehicle 200 can include one or more modules, at least some of which are described herein. The modules can be implemented as computer-readable program code that, when executed by a processor 210, implement one or more of the various processes described herein. One or more of the modules can be a component of the processor(s) 210, or one or more of the modules can be executed on and/or distributed among other processing systems to which the processor(s) 210 is operatively connected. The modules can include instructions (e.g., program logic) executable by one or more processor(s) 210.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-10, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™ Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

As used herein, the term “detent” is meant to encompass any physical structure that can be moved from a non-extended position to an extended position, where an object is secured on a surface when the detent is in the extended position and where the detent is fully or partially disposed within a hole in the surface when the detent is in the non-extended position. A detent may be, but is not limited to, a rod, a pin, or a plate.

Aspects herein can be embodied in other forms without departing from the spirit or essential attributes thereof. Accordingly, reference should be made to the following claims, rather than to the foregoing specification, as indicating the scope hereof.

What is claimed is:

1. A computing system for securing an object on a vehicle surface within a vehicle, the computing system comprising:
a processor; and
memory communicably coupled to the processor and storing instructions that, when executed by the processor, cause the processor to:
identify a subset of detents in a plurality of detents disposed within the vehicle surface based upon sensor data generated by internal sensors of the vehicle, wherein the sensor data is indicative of dimensions of an object located on the vehicle surface; and
transmit a signal to an actuator of the vehicle, wherein the signal causes the actuator to extend the subset of detents from a non-extended position to an extended position, and wherein the subset of detents conforms to the dimensions of the object when the subset of detents is in the extended position.

2. The computing system of claim 1, wherein the instructions further cause the processor to:
responsive to receiving an indication, transmit a second signal to the actuator of the vehicle, wherein the second signal causes the actuator to retract the subset of detents from the extended position to the non-extended position.

3. The computing system of claim 1, wherein the instructions further cause the processor to:
prior to identify the subset of detents, receive a first indication that a transmission system of the vehicle has been shifted from a parking gear to a non-parking gear, wherein identify the subset of detents occurs responsive to receive the first indication that the transmission system of the vehicle has been shifted from the parking gear to the non-parking gear;
subsequent to transmit the signal to the actuator of the vehicle, receive a second indication that the transmission system of the vehicle has been shifted from the non-parking gear to the parking gear; and
responsive to receive the second indication, transmit a second signal to the actuator of the vehicle, wherein the second signal causes the actuator to retract the subset of detents from the extended position to the non-extended position.

4. The computing system of claim 1, wherein the subset of detents encloses the object in an area on the vehicle surface when the subset of detents is in the extended position, wherein the object has a first surface and a second surface, wherein the first surface of the object makes contact with the vehicle surface, and wherein when the vehicle undergoes a change in acceleration, sides of the subset of detents make contact with the second surface of the object when the subset of detents is in the extended position, thereby preventing the object from moving outside of the area.

5. The computing system of claim 1, wherein the plurality of detents includes a second subset of detents, wherein the second subset of detents is located directly beneath the object on the vehicle surface, wherein the second subset of detents is in the non-extended position when the subset of detents is in the extended position.

6. The computing system of claim 5, wherein the instructions for identify the subset of detents in the plurality of detents disposed within the vehicle surface based upon the sensor data generated by the internal sensors of the vehicle comprise further instructions to:
receive force measurements of force applied to each of the plurality of detents; and
for each force measurement in the force measurements:
when a force measurement for a detent is equal to or below a threshold value, identify the detent as being in the subset of detents; and
when the force measurement for the detent is above the threshold value, identify the detent as being in the second subset of detents.

7. The computing system of claim 5, wherein the plurality of detents includes a third subset of detents, wherein the third subset of detents is located outside of an area on the vehicle surface enclosed by the subset of detents, and wherein the third subset of detents is in the non-extended position when the subset of detents is in the extended position.

8. The computing system of claim 1, wherein the instructions further cause the processor to:
prior to identify the subset of detents, receive a first indication that a door of the vehicle has been closed, wherein identify the subset of detents occurs responsive to receive the first indication that the door of the vehicle has been closed;
subsequent to transmit the signal to the actuator of the vehicle, receive a second indication that the door of the vehicle has been opened; and
responsive to receive the second indication, transmit a second signal to the actuator of the vehicle, wherein the second signal causes the actuator to retract the subset of detents from the extended position to the non-extended position.

9. A system for securing an object on a vehicle surface within a vehicle, the system comprising:
the vehicle surface;
a plurality of detents disposed within the vehicle surface;
an actuator that is configured to apply uniform pressure to the plurality of detents, wherein the uniform pressure extends a subset of detents in the plurality of detents from a non-extended position to an extended position, and wherein the subset of detents conforms to dimensions of the object; and
a controller that is configured to transmit a signal to the actuator which causes the actuator to apply the uniform pressure.

10. The system of claim 9, wherein the uniform pressure is applied in a direction that is orthagonal to the vehicle surface and upwards from the vehicle surface.

11. The system of claim 9, wherein a second subset of detents in the plurality of detents makes contact with a surface of the object when the actuator applies the uniform pressure, and wherein a weight of the object prevents the second subset of detents from extending from the non-extended position to the extended position when the actuator applies the uniform pressure.

12. The system of claim 9, wherein the actuator is one of:
an electromechanical acutator;
an electromagnetic actuator;
a hydraulic actuator; or
a pneumatic actuator.

13. The system of claim 9, further comprising:
detent locks that are configured to lock the subset of detents in the extended position subsequent to the uniform pressure being applied.

14. A method comprising:
identifying a subset of detents in a plurality of detents disposed within a vehicle surface of a vehicle based upon sensor data generated by internal sensors of the vehicle, wherein the sensor data is indicative of dimensions of an object located on the vehicle surface; and
transmiting a signal to an actuator of the vehicle, wherein the signal causes the actuator to extend the subset of detents from a non-extended position to an extended position, and wherein the subset of detents conforms to the dimensions of the object when the subset of detents is in the extended position.

15. The method of claim 14, further comprising:
prior to identifying the subset of detents, receiving an indication that a button within the vehicle has been presssed, wherein identifying the subset of detents occurs responsive to receiving the indication.

16. The method of claim 14, wherein identifying the subset of detents in the plurality of detents disposed within the vehicle surface of the vehicle based upon the sensor data generated by the internal sensors of the vehicle comprises:
receiving an image of the object on the vehicle surface from a camera;
determining an area on the vehicle surface that is occupied by the object based upon the image of the object; and
selecting the subset of detents based upon the area, wherein the subset of detents is located outside of the area.

17. The method of claim 14, wherein the vehicles surface is located in a cargo area of the vehicle.

18. The method of claim 14, wherein the actuator extends the subset of detents in an upwards direction when the actuator extends the subset of detents from the non-extended position to the extended position.

19. The method of claim 14, wherein when the subset of detents is in the extended position, the object is secured on the vehicle surface when the vehicle undergoes a change in acceleration.

20. The method of claim 14, further comprising:
determining a height of the object based upon the sensor data, wherein a degree to which the subset of detents is extended in the extended position is based upon the height of the object.
